(19) United States
(12) Patent Application Publication
(10) Pub. No.: US 2026/0054830 A1
(43) Pub. Date: Feb. 26, 2026

(54) VTOL Aircraft Using Fixed Forward Canted Rotors With Forward-Facing Rotors

(71) Applicant: Joby Aero, Inc., Santa Cruz, CA (US)

(72) Inventors: Gregor Veble Mikic, Santa Cruz, CA (US); JoeBen Bevirt, Santa Cruz, CA (US)

(21) Appl. No.: 18/755,692

(22) Filed: Jun. 27, 2024

Related U.S. Application Data
(60) Provisional application No. 63/525,371, filed on Jul. 7, 2023.

(51) Int. Cl. B64C 29/00

(52) U.S. Cl. CPC B64C 29/0025

(57) ABSTRACT

A vertical take-off and landing aircraft which uses fixed rotors for both VTOL and forward flight operations. Some of the rotors are forward canted, while some of the rotors are forward facing. The forward canted rotors are tilted forward slightly from vertical and provide some forward propulsion during horizontal flight. The forward facing rotors may be fixed in a forward facing configuration. Forward swept wings allow for rotor placement which brings efficiency during hover operations.

### CROSS-REFERENCE TO RELATED APPLICATIONS

This application claims priority to U.S. Provisional Ser. No. 63/525,371 to Gregor Veble Mikic et al., filed Jul. 7, 2023, which is hereby incorporated by reference in its entirety.

### FIELD OF THE INVENTION

This invention relates to aerial vehicles, an aerial vehicle using forward canted rotors and forward-facing rotors.

### BRIEF DESCRIPTION OF THE DRAWINGS

FIGS. 1A-B are views of an aerial vehicle forward canted and forward-facing rotors according to some embodiments of the present invention.

FIGS. 2A-B are views of an aerial vehicle forward canted and forward-facing rotors according to some embodiments of the present invention.

FIGS. 3A-B are views of an aerial vehicle forward canted and forward-facing rotors according to some embodiments of the present invention.

FIG. 4 is a view of an aerial vehicle forward canted and forward-facing rotors according to some embodiments of the present invention.

FIGS. 5A-B are views of a rotor with rotor cover according to some embodiments of the present invention.

FIGS. 6A-C are views of a rear rotor cowling according to some embodiments of the present invention.

FIGS. 7A-C are views illustrating a rotor according to some embodiments of the present invention.

### SUMMARY

A vertical take-off and landing aircraft which uses fixed rotors for both VTOL and forward flight operations. Some of the rotors are forward canted, while some of the rotors are forward-facing. The forward canted rotors are tilted forward slightly from vertical and provide some forward propulsion during horizontal flight. The forward-facing rotors may be fixed in a forward-facing configuration. The aircraft may engage in VTOL operations and forward flight without the use of controllable control surfaces.

### DETAILED DESCRIPTION

In some embodiments, an aerial vehicle has fixed forward canted rotors and some fixed forward-facing rotors. In some embodiments, the rotors are fixedly mounted to structures coupled to the aerial vehicle main body. The forward canted rotors may be staggered along the longitudinal axis of the aerial vehicle such that differential thrusting along the longitudinal axis allows for forward pitch of vehicle in order to provide a forward thrust component from the rotors. In some aspects, differential thrusting may be used to trim the aircraft during flight In some aspects, pitch control may also be achieved using other means, such as elevator control. In some embodiments, the rotors may have some articulable aspects. In some aspects, the rotors are fixedly mounted without articulable aspects. In some aspects, the aircraft controls pitch, roll, and yaw by differentiating thrust of the rotors and without other control surfaces. In some aspects, the aircraft does not have other controllable surfaces for attitude control.

Aerial vehicles according to embodiments of the present invention are adapted for vertical take-off and landing using the wing rotors. For take-off the wing-rotors are spun up to a speed in the range of their hover rpm. In embodiments wherein the wing rotors have their spin axis tilted forward relative to the horizontal axis of the aerial vehicle, the aerial vehicle will be pitched up during take-off and landing such that the plane of the forward canted wing rotors is horizontal. After take-off the aerial vehicle may spin up the forward-facing rotors while the forward canted rotors are still under power. As the aerial vehicle gains forward speed, lift is generated by the wings, and the proportion of lift provided by the wing rotors decreases. As the aircraft approaches its cruise velocity, the wing rotors typically have their rpms reduced, but they stay under power and provide a portion of the total lift of the aerial vehicle. In some aspects, the wing rotors may be reduced in power such that they provide negligible lift, but are spinning and able to be quickly spun up to provide attitude control of the aircraft.

An aerial vehicle according to embodiments of the present invention will be able to engage in hover, take-off, landing, and forward flight including all required maneuvering and attitude adjustments by manipulating the speeds of individual rotors, and without the need for any further control surfaces. In some embodiments, the aerial vehicle will not have ailerons, or elevators, or any other controllable control surfaces. In such a circumstance, with fixed tilt rotors being used for attitude control, the total simplicity of the design and system provides significant advantages. The forward canted rotors may also be in a forward or rearward swept configuration such that the rotors are at different stations along the roll axis of the aircraft. In other embodiments, there are forward and rearward forward canted rotors which are forward and rearward, respectively, of the wing and of the aircraft center of mass. With the differential stations along the roll axis, the wing rotors are then able to provide control around the pitch axis. With spacing at distances further out from the aircraft body, the wing rotors are able to provide control around the roll axis.

In some aspects, some of the rotors on each side of the aircraft may spin in a first direction, while others spin in the opposite direction. In such a circumstance, yaw may be controlled by altering the speeds and/or torques of the rotors spinning in the first direction relative to those spinning in the opposite direction. In some aspects, rotors on each side of the aircraft body may be set at slightly different forward tilt angles. In such a circumstance, yaw control may be achieved by altering the relative speed and/or thrust of the different rotors and slightly different tilt angles.

In some aspects, the forward canted rotor assemblies have a spin axis that is not vertical relative to the constant altitude cruise plane of the aircraft, but are tilted forward at an angle. In some aspects, the rotors are tilted forward in the range of 5-20 degrees. In some aspects, the rotors are tilted forward in the range of 5-15 degrees. In some aspects, the rotors are tilted forward in the range of 8-20 degrees. In some aspects, the rotors are tilted forward in the range of 8-12 degrees. In an exemplary embodiment, the rotors are tilted at 10 degrees. In some aspects, the rotors are tilted at different angles within the aforementioned ranges, allowing for yaw control. The tilt angle may be defined as the angle between the rotor axis and the mean aerodynamic chord line of the wing.

The efficiency of the aircraft (lift/drag ratio) during forward flight may be sought to be as high as feasible while balancing other aircraft parameters. For example, the ratio of the tip speed of the spinning wing rotors during forward flight to velocity of the aircraft during forward flight is an important ratio to consider when designing for efficiency. Also, the percentage of lift provided by the wing rotors relative to the total lift (wings plus wing rotors) is an important ratio to consider when designing for efficiency. Also, the ratio of the power distribution between the wing rotors and the total power delivered to both the wing rotors and the traditional forward thrust propellers is an important ratio to consider when designing for efficiency. The interplay between these ratios may be complex and does not lend itself to obvious optimization. An underlying design parameter is that the wing rotors provide sufficient vertical thrust during vertical take-off and landing to safely take-off and land the aircraft.

Aerial vehicles according to embodiments of the present invention are adapted for vertical take-off and landing using the wing rotors. For take-off the wing-rotors are spun up to a speed in the range of their hover rpm. In embodiments wherein the wing rotors have their spin axis tilted forward relative to the horizontal axis of the aerial vehicle, the aerial vehicle will be pitched up during take-off and landing such that the plane of the wing rotors is horizontal.

After take-off the aerial vehicle may spin up forward pushing (or pulling) propellers, such as wing mounted forward-facing propellers, while the wing rotors are still under power. As the aerial vehicle gains forward speed, lift is generated by the wing, and the proportion of lift provided by the wing rotors decreases. As the aircraft approaches its cruise velocity, the wing rotors typically have their rpms reduced, but they stay under power and provide a portion of the total lift of the aerial vehicle.

Another factor to be considered is the fraction of lift carried by the wing rotors relative to the total lift provided by both the wing(s) and wing rotors during forward flight. In an embodiment wherein all attitude control, including roll control, is induced or maintained by manipulation of wing rotor motor speeds, the fraction of lift provided by the wing rotors must be high enough to allow the manipulation of the wing rotors to be effective in controlling the aircraft attitude. In some aspects, the fraction of the lift provided by the wing rotors at cruise speed is greater than 0.2. In some aspects, the fraction of the lift provided by the wing rotors is greater than 0.25. In some aspects, the fraction of the lift provided by the wing rotors is greater than 0.3. In some aspects, the fraction of lift provided by the wing rotors is in the range of 0.2 to 0.4. In some aspects, the fraction of lift provided by the wing rotors is in the range of 0.1 to 0.5. The fraction of lift provided represents to total of all of the wing rotors in nominal forward flight relative to the wing, but in some aspects certain rotors may be spun down to a lower speed in support of aerodynamic control of the aircraft. In some aspects, one or more rotors may temporarily produce negative lift in support of certain control operations.

Another factor to be considered is the ratio of the tip speed of the wing rotors relative to the velocity of the aircraft during forward flight. This factor may come into play as one or more wing rotors is lowered in speed to reduce lift on one of the wings to effect roll. In such a maneuver, the wing rotors on the other wing may be spun up to increase lift. A risk of stall occurs on the retreating rotor blades when run nominally at a low multiple of aircraft velocity. In some aspects, the nominal cruise wing rotor tip velocity is greater than 2.0 times the aircraft cruise speed. In some aspects, the nominal cruise wing rotor tip velocity is greater than 2.5 times the aircraft cruise speed. In some aspects, the nominal cruise wing rotor tip velocity is greater than 1.5 times the aircraft cruise speed. In some aspects, the nominal cruise wing rotor tip velocity is greater than 1.0 times the aircraft cruise speed. In some aspects, the nominal cruise wing rotor tip velocity may be as low as greater than 0.5 times the aircraft cruise speed. The tip velocity is understood to be the angular velocity of the blades times their radial length.

The factors discussed above have been modeled to determine the lift to drag ratio L/De (effective drag) for the aerial vehicle as a function of the tip speed of the wing versus the aircraft forward speed against the angle of attack of the aircraft. The effective drag is the combined shaft power of the aircraft divided by the aircraft forward velocity. The lift to drag ratio is modeled at different forward tilt angles for the wing rotors, and also with different wing rotor blade pitches. It has been discovered that a non-obvious range of parameters give operational modes with the highest lift to drag ratio. A preferred outcome is to have the lift to drag ratio above 8 within constraint values discussed above, with higher ratios of 9 or 10 even more desirable.

In some aspects, the aerial vehicle has wings with significant forward sweep, allowing for structural coupling of the wings significantly rearward of most of the passenger and/or payload compartment. The forward sweep also allows for an evenly spaced configuration of wing mounted rotors such that during VTOL hover operations each vertical thrusting rotor is opposite another vertical thrusting rotor along a line through the aircraft center of mass, as seen in the Figures and discussed further below. With the forward sweep, an outboard vtol rotor can be located rearward of the wing, to minimize downwash effects on the wing, but nonetheless located along the lateral extension of the center of mass of the aircraft during hover. Similarly, the inboard forward and inboard rearward vtol rotors are located away from the wings to minimize downwash effects on the wings, but to the extent that the downwash does impinge upon the wings it does so at a location where the wing is along the lateral extension of the center of mass during hover, reducing control perturbations. Also, with forward sweep the attach points rearward of the bulk of the passenger/payload area allows the payload to easier reside at the longitudinal location of the center of mass without encumbrance of the wing attach structural members.

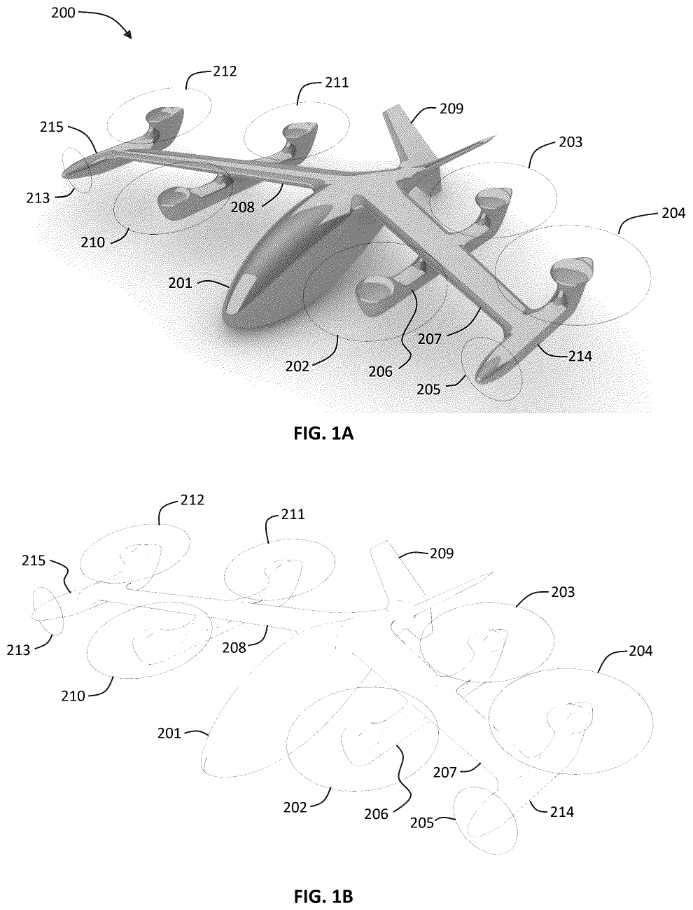

In some embodiments of the present invention, as seen in FIGS. 1-5, an aerial vehicle 200 has a right side wing 208 and a left side wing 207 which are coupled to the aerial vehicle main body 201. The wings 207, 208 are forward swept and couple to the aerial vehicle main body 201 significantly rearward of the center of lift and the center of mass of the aerial vehicle 200, allowing for use of the interior of the main body for passengers, pilots, and/or payload without obstruction by the structural components needed for the attachment of the wings to the main body. The left side wing 207 has an inboard forward vtol rotor 202, an inboard rearward vtol rotor 203, and an outboard vtol rotor 204. The inboard forward vtol rotor 202, the inboard rearward vtol rotor 203, and the outboard vtol rotor 204 may be fixed in a forward canted orientation. The left wing 207 also has a forward-facing rotor 205. The right side wing 208 has an inboard forward vtol rotor 210, an inboard rearward vtol rotor 211, and an outboard vtol rotor 212. The inboard forward vtol rotor 210, the inboard rearward vtol rotor 211, and the outboard vtol rotor 212 may be fixed in a forward canted orientation. The right wing 208 also have a forward-facing rotor 213. In some aspects, each of the vtol rotors 202, 203, 204, 210, 211, 212 are tilted forward in the range of 5-20 degrees. In some aspects, each of the rotors are tilted forward in the range of 5-15 degrees. In some aspects, each of the rotors are tilted forward in the range of 8-20 degrees. In some aspects, the rotors are tilted forward in the range of 8-12 degrees. As described herein, the vtol rotors 202, 203, 204, 210, 211, 212 are understood to be rotor assemblies which include a motor and a propeller. In some aspects, the motors are electric motors. In some aspects, the propellers have fixed-pitch propeller blades. In some aspects, the propellers have variable-pitch propeller blades. The Figures utilize circles to demonstrate the blade disc area.

In some aspects, the inboard vtol rotors are supported by inboard span supports 206, 216 which can be viewed as having forward portions and rear portions although the span supports themselves may be a continuous support. The inboard span supports 206, 216 are coupled to the wings 207, 208. A front inboard vtol rotor may have a top cover and a rear portion adapted for aerodynamic drag minimization. The outboard vtol rotors 204, 212 may also be coupled to the outboard tip or portion of the wings 207, 208 at the rearward end of outboard span supports 214, 215, and the forward-facing rotors 205, 213 may be coupled to forward end of the outboard span supports 214, 215.

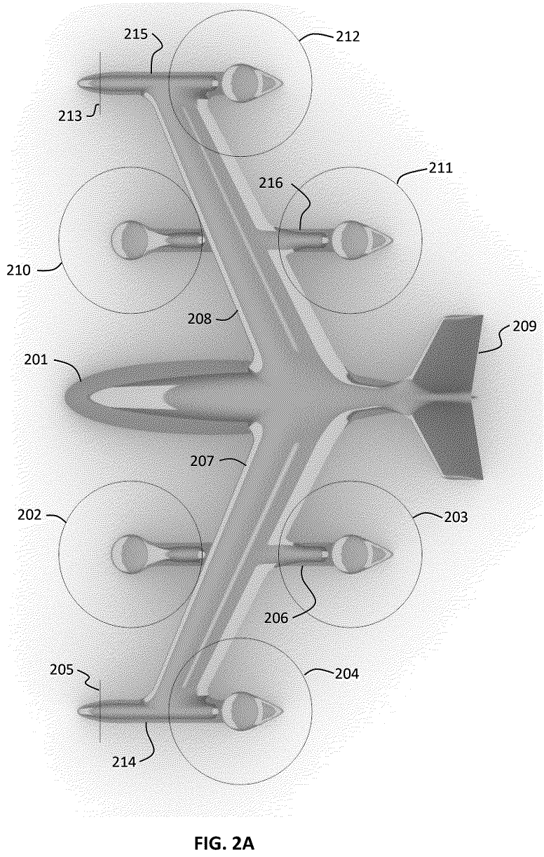

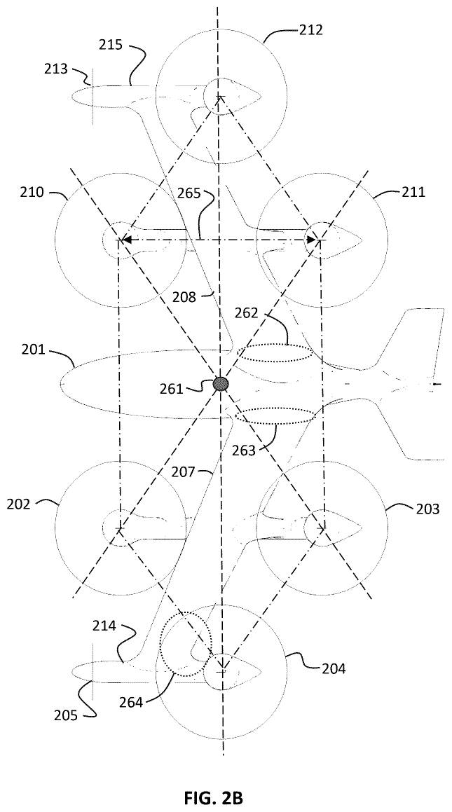

FIG. 2B illustrates a top view of the aerial vehicle 200 according to some embodiments of the present invention, demonstrating features of the aerial vehicle with regard to wing sweep, wing coupling, and rotor locations. In this representative embodiment, each of the inboard vtol rotors is paired to another inboard vtol rotor via a line through a center point of the aerial vehicle. The left forward inboard vtol rotor 202 is paired through the center point 261 with the right side rearward inboard vtol rotor 211. The right forward inboard vtol rotor 210 is paired through the center point 261 with the left side rearward inboard vtol rotor 203. For the purposes of this application, the center point is defined as the crossing point of the line between the right forward inboard vtol rotor center and left rearward inboard vtol rotor center, and the line between the left forward inboard vtol rotor center and right rearward inboard vtol rotor center. The right outboard vtol rotor 212 is ideally also paired through the center point 261 with the left outboard vtol rotor 204. In some aspects, the longitudinal location of the line between the right outboard vtol rotor 212 and the left outboard vtol rotor 204 is located within a longitudinal distance range from the center point, as discussed further below. In some aspects, the center of gravity of the aerial vehicle and the aerodynamic center of the aerial vehicle overlap or nearly overlap with the center point.

With the use of forward swept wings 207, 208 the wings are coupled to the main body 201 rearward of the center point 261 of the aerial vehicle. The right wing 208 may have internal structures, or spars, which couple into the aircraft in an area 262 which is located to the rear of the main body such that a passenger/pilot/payload area in the main body, forward of the wing attach area 262, is not encumbered by such structure. Similarly, the left wing 207 may have internal structures, or spars, which couple into the aircraft in an area 263 which is located to the rear of the main body such that a passenger/pilot/payload area in the main body, forward of the wing attach area 263, is not encumbered by such structure. In some aspects, the wing attach structures, or spars, are coupled to the aircraft main body rearward of the cg of the aerial vehicle. In some aspects, the entirety of the wing attach structures, or spars, are coupled to the aircraft main body rearward of the cg of the aerial vehicle. In some aspects the entirety of the wings 207, 208 are coupled to the aircraft main body rearward of the cg of the aerial vehicle. In some aspects the entirety of the wings 207, 208 are coupled to the aircraft main body rearward of the center point 261 of the aerial vehicle.

The configuration of the outboard spar supports 214, 215, and the associated forward-facing rotors 205, 213 and the outboard vtol rotors 204, 212, in conjunction with the forward swept wing offers additional advantages. The outboard rotors 204, 212 are able to mounted rearward of the wings 207, 208 to both provide downwash clearance during hover and to allow for the location of the outboard vtol rotors 204, 212 laterally outboard but longitudinally aligned with the center point 261 of the aerial vehicle. In addition, the forward location of the forward-facing rotors 205, 213 relative to the wings 207, 208, on the front ends of the outboard span supports 214, 215 provides mass forward of the wings at their tips. The divergent aeroelastic torsion commonly seen in forward-swept wing designs is substantially reduced by the presence of the masses cantilevered forward of the wing, which create opposing torque.

In some aspects, the longitudinal location of the outboard vtol rotors resides at the midpoint of the longitudinal locations of the forward and rearward inboard vtol rotors. In some aspects, the midpoint of the longitudinal locations of the forward and rearward inboard vtol rotors are separated by a first distance 265, and the longitudinal location of the outboard vtol rotors resides within 25% of the center point 261. In some aspects, the longitudinal location of the outboard vtol rotors resides within 20% of said first distance from the midpoint of the longitudinal locations of the forward and rearward inboard vtol rotors. In some aspects, the longitudinal location of the outboard vtol rotors resides within 10% of said first distance from the midpoint of the longitudinal locations of the forward and rearward inboard vtol rotors.

In some aspects, the inboard span supports 206, 216 are located along the forward swept wing at an outboard(from the longitudinal centerline of the aerial vehicle) location such that the forward and rearward inboard vtol rotors are longitudinally equidistant from the center point, the center of gravity, and are also located at a position on the wing where the wing is crossed by a line between the forward and rearward inboard vtol rotors at a neutral point of the wing.

In some aspects, the rotation directions of the vtol rotors are configured to better accommodate a failure of a vtol rotor. The inboard vtol rotors on each side will rotate in the same, first, direction, while the inboard vtol rotors on the side opposite will rotate in the same direction, opposite to the first direction. For example, the right side inboard vtol rotors may rotate clockwise, while the left side inboard rotors will rotate counter-clockwise. Further, the outboard vtol rotors on each side will rotate in the direction of rotation of the inboard vtol rotors on that side. This configuration then creates a favorable situation wherein should a vtol rotor fail, the vtol rotor across the center point from that failed vtol rotor can be spun down (to provide no or less thrust), and in each case the two vtol rotors now not operating will have had been rotating in opposite directions. Thus, the remaining vtol rotors will have an equal number of clockwise and counter-clockwise vtol rotors remaining, providing a desired torque balance. This will be the case no matter which pair of vtol rotors are unpowered.

Another aspect of the aerial vehicle with regard to wing sweep, wing coupling, and rotor locations is that each of the various vtol rotors is located substantially free of any blockage of the thrust during hover operations. The only apparent impingement may be on the outboard vtol rotors, which may have a small area 264 which is subject to downwash. However, as the vtol rotors are fixed in a forward canted position, the aerial vehicle will be slightly pitched up during hover to provide vertical thrust. This pitched up attitude of the aerial vehicle will slightly reduce the area of wing below the outboard vtol rotors and the inboard rearward vtol rotors, as well as increase the non-horizontal presentation of the surfaces which may be impinged upon.

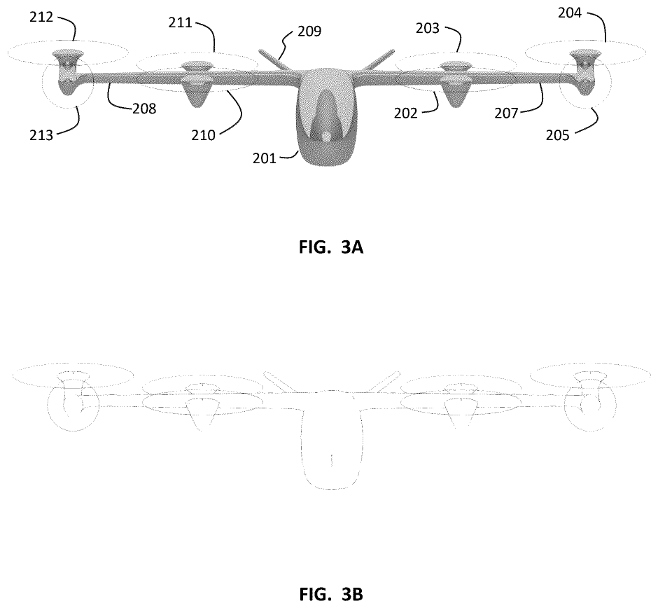

FIGS. 3A-B are front views of the aerial vehicle 200 in a nominal forward flight configuration illustrating the forward cant of the vtol rotors 202, 203, 204, 210, 211, 212, as well as the higher elevation of the rearward inboard vtol rotors 203, 211 relative to the forward inboard vtol rotors 202, 210. Similarly, the outboard vtol rotors 204, 212 are also substantially raised above the spin axis of the forward-facing rotors 205, 213.

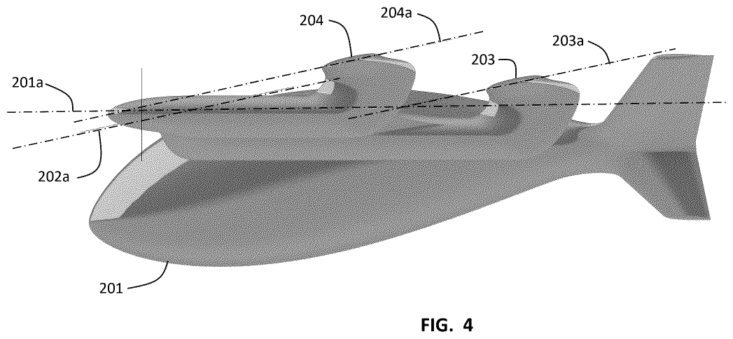

FIG. 4 illustrates the forward cant angles of the various vtol rotors relative to the forward flight path line according to some embodiments of the present invention. The forward flight path line 201a represents the forward flight path during a nominal horizontal flight. The left rearward inboard vtol rotor 203 has its propeller disc plane 203a canted in a fixed forward position, as discussed above. The right rearward inboard vtol rotor 202 has its propeller disc plane 202a canted in a fixed forward position, as discussed above. The outboard vtol rotor 204 has its propeller disc plane 204a canted in a fixed forward position, as discussed above.

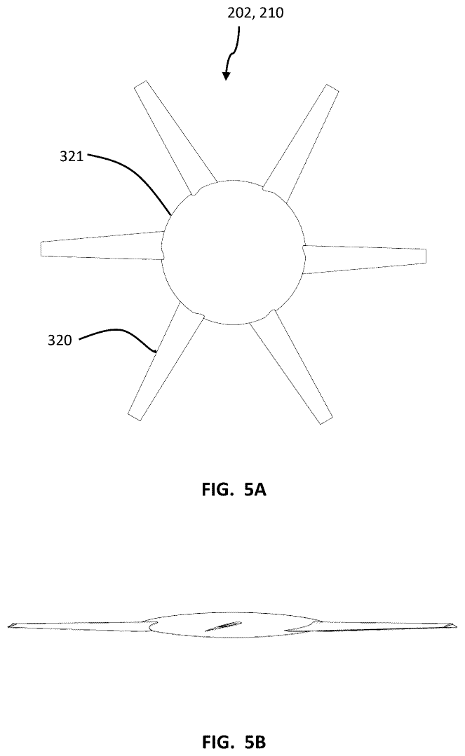

FIGS. 5A-B illustrates an inboard vtol rotor 202, 210 according to some embodiments of the present invention. As seen, there is large diameter of the rotor cover 321 at the inboard end of the rotor blades 320 forming a central hub of the inboard vtol rotors. In such a configuration, the inboard end of the rotor blade 220 is less susceptible to have its retreating blade stall as compared to a configuration where the propeller blade continues further towards the spin axis. This large center area of the rotor cover allows for placement of the individual motor within the outer surface of the rotor cover (or pair of motors in a counter-rotating blade configuration). Thus, the rotor blades may begin radially outboard (relative to the spin axis) of the motor itself. The rotor cover diameter may be larger than the outside diameter of the motor in some aspects.

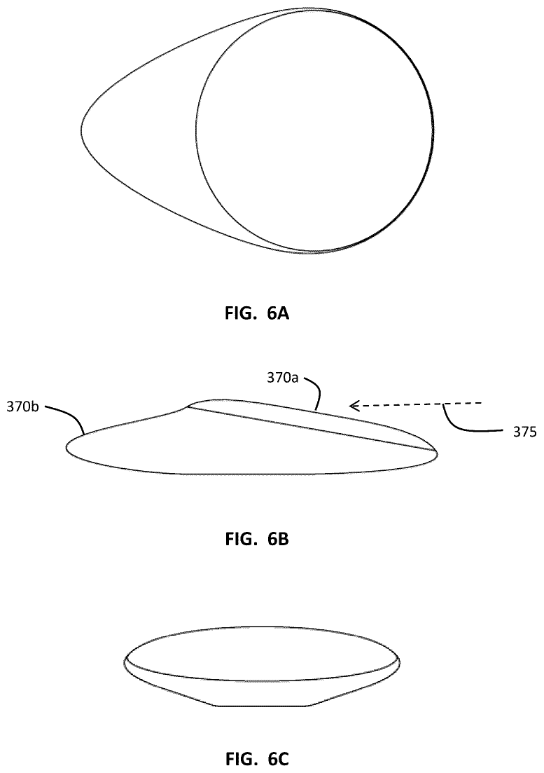

FIGS. 6A-C illustrate aspects of the rearward inboard vtol rotors 203, 211 and the outboard vtol rotors 204, 212 with a central hub and top cover 370a and an extended rear portion under cowling 370b. As the rotor assembly will maintain a forward tilt from vertical of 10 degrees, for example, or another value as discussed above, the extended rear portion 370b facilitates a pressure recovery region to avoid flow separation. In some aspects, the extended rear portion undercowling may be a part of a continuous aerodynamic structure which couples with the exterior surface of the aerodynamic span supports 206, 216. In some aspects, the extended rear portion undercowling may be more distinct from adjacent structure, as seen in FIG. 13B. In a typical embodiment, the motor, which may be an electric motor, resides within the top cover and the undercowling.

Representative airflow 375 across the top cover 370a and the extended rear portion under cowling 370b during forward flight is illustrated in FIG. 6B.

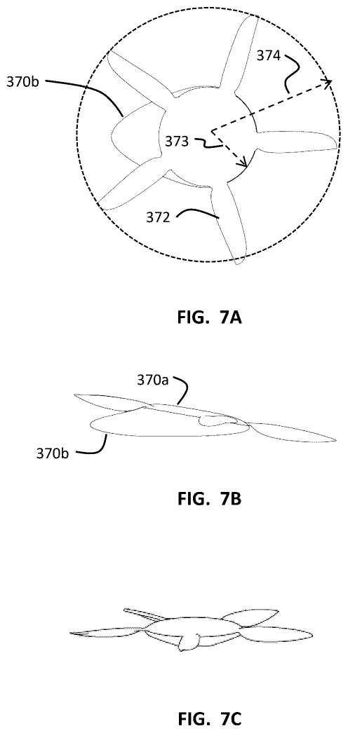

FIGS. 7A-C illustrates a rotor assembly 203, 204, 211, 212 with blades 372. The top cover 370a will rotate with the blades while the extended rear portion 370b of the rotor assembly will remain fixed with the aircraft body. Another aspect of the rotor assembly is the ratio of the radius 373 of the rotor's central hub top cover 370a to the radius 374 of the blade disc. As discussed above, a rotor cap 370a with a larger radius pushes out the inboard end of the blade 372, and reduces the circumstances where there may be stall on the retreating blades during forward flight. In some aspects, the ratio of the radius of the rotor cap to the radius of the blade disc is greater than 0.25. In some aspects, the ratio of the radius of the rotor cap to the radius of the blade disc is greater than 0.30. In some aspects, the ratio of the radius of the rotor cap to the radius of the blade disc is greater than 0.20.

Forward canted rotors 202, 203, 204 may have a central hub, which may include an electric motor, and the blades. The central hub may have an electric motor within it, and may have an exterior surface adapted for low drag when in a forward flight configuration. A. The inboard front rotor 202 and the inboard rear rotor may be coupled to a boom 206. The outboard rear rotor may be coupled to an outboard boom. A front facing motor 205 is configured to provide horizontal thrust in a nominal forward flight configuration. In some aspects, the motors are powered by an electric power source, such as a battery or plurality of batteries.

In some aspects, there is significant radius of the rotor at the inboard end of the rotor blades. In such a configuration, the inboard end of the rotor blade is less susceptible to have its retreating blade stall as compared to a configuration where the blade routes further towards the spin axis. This center area of the rotor allows for placement of the individual motor within the outer surface of the rotor (or pair of motors in the counter-rotating blade configuration). Thus, the rotor blades may begin radially outboard (relative to the spin axis) of the motor itself. The rotor diameter may be larger than the outside diameter of the motor in some aspects.

In some aspects, the configuration of the wings 207, 208 as shown allows for the aerodynamic center of the wings to be rearward of the center of mass of the aerial vehicle, which may enhance the control and stability of the aerial vehicle in forward flight. Also, it may be desirable to have the wings coupled to the body of the aerial vehicle rearward of the location of the pilot, occupants, or cargo. In some aspects, there are internal structural elements which couple the wings to the body, and to each other, which may traverse the inside of the body of the aerial vehicle. Also, these internal structural elements may be at the top of the aircraft body, as the wings may be structurally coupled to the aircraft body at or near the top of the aircraft body. With this higher elevation coupling and the associated internal structural supports, the wing may need to be coupled to the aircraft body rearward of the head of the pilot as the pilot sits in the aircraft body.

In some aspects, the extended rear portion undercowling may be more distinct from adjacent structure, as seen in FIG. 4. In a typical embodiment, the motor, which may be an electric motor, resides within the rotor assembly.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. An aerial vehicle adapted for vertical takeoff and horizontal flight using rotors to simulate traditional wing aerodynamics, said aerial vehicle comprising:
a main vehicle body;
a right side wing assembly, said right side wing assembly comprising:
a right side wing:
a plurality of right side wing forward canted rotor assemblies wherein the spin axis of each of said right side wing rotor assemblies is tilted forward in a fixed orientation, said plurality of right side wing rotor assemblies comprising:
a right side forward inboard rotor assembly forward of said right side wing, said right side forward inboard rotor assembly coupled to an inboard portion of said right side wing;
a right side rearward inboard rotor assembly rearward of said right side wing, said right side rearward inboard rotor assembly coupled to an inboard portion of said right wing; and
a right side outboard rotor assembly coupled to a tip of said right side wing; and
a right side forward facing rotor assembly; and
a left side wing assembly, said left side wing assembly comprising:
a plurality of left side wing forward canted rotor assemblies wherein the spin axis of each of said left side wing rotor assemblies is tilted forward in a fixed orientation, said plurality of left side wing rotor assemblies comprising:
a left side forward inboard rotor assembly forward of said left side wing, said left side forward inboard rotor assembly coupled to an inboard portion of said left side wing;
an left side rearward inboard rotor assembly rearward of said left side wing, said left side rearward inboard rotor assembly coupled to an inboard portion of said left wing; and
a left side outboard rotor assembly coupled to a tip of said left side wing; and
a left side forward facing rotor assembly.

2. The aerial vehicle of claim 1 wherein said right side wing and said left side wing are forward swept.

3. The aerial vehicle of claim 2 wherein the intersection of a line between a center of said left side forward inboard vtol rotor and a center of said right side rearward vtol rotor and a line between a center of said right side forward inboard vtol rotor and a center of said left side rearward inboard vtol rotor defines a center point, and wherein said right side wing and said left side wing are structurally coupled to said main vehicle body rearward of said center point.

4. The aerial vehicle of claim 3 wherein the entirety said right side wing and said left side wing are coupled to said main vehicle body rearward of said center point.

5. The aerial vehicle of claim 2 further comprising:
a right side inboard span support, said right side inboard span support coupled to said right side wing, wherein said right side forward inboard rotor assembly is coupled to a front end of said right side inboard span support, and wherein said right side rearward rotor assembly is coupled to a rear end of said right side inboard span support; and
a left side inboard span support, said left side inboard span support coupled to said left side wing, wherein said left side forward inboard rotor assembly is coupled to a front end of said left side inboard span support, and wherein said left side rearward rotor assembly is coupled to a rear end of said left side inboard span support.

6. The aerial vehicle of claim 5 further comprising:
a right side outboard span support, said right side outboard span support coupled to said right side wing, wherein said right side forward facing rotor assembly is coupled to a front end of said right side outboard span support, and wherein said right side outboard rotor assembly is coupled to a rear end of said right side outboard span support; and
a left side outboard span support, said left side outboard span support coupled to said left side wing, wherein said left side forward facing rotor assembly is coupled to a front end of said left side outboard span support, and wherein said left side outboard rotor assembly is coupled to a rear end of said left side outboard span support.

7. The aerial vehicle of claim 6 wherein the spin axis of said right side forward canted rotor assemblies is tilted forward at an angle to the normal of the horizontal flight line of the aerial vehicle in nominal forward flight in the range of 5-20 degrees, and wherein the spin axis of said left side forward canted rotor assemblies is tilted forward at an angle to the normal of the horizontal flight line of the aerial vehicle in nominal forward flight in the range of 5-20 degrees.

8. The aerial vehicle of claim 6 wherein the spin axis of said right side forward canted rotor assemblies is tilted forward at an angle to the normal of the horizontal flight line of the aerial vehicle in nominal forward flight in the range of 5-15 degrees, and wherein the spin axis of said left side forward canted rotor assemblies is tilted forward at an angle to the normal of the horizontal flight line of the aerial vehicle in nominal forward flight in the range of 5-15 degrees.

9. The aerial vehicle of claim 6 wherein the spin axis of said right side forward canted rotor assemblies is tilted forward at an angle to the normal of the horizontal flight line of the aerial vehicle in nominal forward flight in the range of 8-12 degrees, and wherein the spin axis of said left side forward canted rotor assemblies is tilted forward at an angle to the normal of the horizontal flight line of the aerial vehicle in nominal forward flight in the range of 8-12 degrees.

10. The aerial vehicle of claim 6 wherein said right side outboard rotor assembly and said left side rotor assembly reside directly outboard of said center point.

11. The aerial vehicle of claim 6 wherein said right side forward inboard rotor assembly and said left side rearward inboard rotor assembly are separated by a first distance, and wherein a line through the center of said right side outboard vtol rotor assembly and said left side outboard vtol rotor assembly crosses a longitudinal axis of the aerial vehicle within 25% of said first distance from said center point.

12. The aerial vehicle of claim 6 wherein said right side forward inboard rotor assembly and said left side rearward inboard rotor assembly are separated by a first distance, and wherein a line through the center of said right side outboard vtol rotor assembly and said left side outboard vtol rotor assembly crosses a longitudinal axis of the aerial vehicle within 20% of said first distance from said center point.

13. The aerial vehicle of claim 2 further comprising a tail assembly, wherein said aerial vehicle has no controllable control surfaces on said right said wing, said left side wing, or said tail.

14. The aerial vehicle of claim 6 further comprising a tail assembly, wherein said aerial vehicle has no controllable control surfaces on said right said wing, said left side wing, or said tail.

15. The aerial vehicle of claim 7 further comprising a tail assembly, wherein said aerial vehicle has no controllable control surfaces on said right said wing, said left side wing, or said tail.

16. The aerial vehicle of claim 7 wherein said right side forward inboard vtol rotor, said right side rearward inboard vtol rotor, and said left side outboard vtol rotor rotate in a first rotation direction, and wherein said left side forward inboard vtol rotor, said left side rearward inboard vtol rotor, and said right side outboard vtol rotor rotate in a first rotation direction.
